(19) United States
(12) Patent Application Publication
(10) Pub. No.: US 2020/0062249 A1
(43) Pub. Date: Feb. 27, 2020

(54) Connected and Autonomous Vehicle (CAV) Behavioral Adaptive Driving

(71) Applicant: Cubic Corporation, San Diego, CA (US)

(72) Inventors: David Light, London (GB); Gavin Smith, Crawley (GB); Steffen Reymann, Guildford (GB)

(73) Assignee: Cubic Corporation, San Diego, CA (US)

(21) Appl. No.: 16/546,519

(22) Filed: Aug. 21, 2019

Related U.S. Application Data
(60) Provisional application No. 62/721,166, filed on Aug. 22, 2018.

(51) Int. Cl. B60W 30/095; G05D 1/00; G07C 5/08; G07C 5/00; G08G 1/16

(52) U.S. Cl. CPC B60W 30/0953; G05D 1/0055; G07C 5/0808; B60W 2550/40; G05D 1/0088; G08G 1/166; B60W 2520/00; G07C 5/008

(57) ABSTRACT

The CAV may include one or more sensors, a communications interface, a driving control configured to be activated to cause a change in the operation of the CAV, and a processing unit communicatively coupled with the one or more sensors, the communications interface, and the driving control. The processing unit may be configured to cause the CAV to: obtain vehicle data regarding a vehicle using the one or more sensors; obtain, using the vehicle data, risk data via the communications interface, the risk data being indicative of a likelihood of an accident caused by the vehicle; determine a risk value based on the risk data regarding the vehicle, the risk value being indicative of a likelihood that the CAV may be involved in an accident; and responsive to determining the risk value is above a threshold level, activate the driving control to modify the operation of the CAV.

### CROSS-REFERENCES TO RELATED APPLICATIONS

This application claims the benefit of U.S. Provisional Patent Application No. 62/721,166, filed Aug. 22, 2018, entitled “Connected and Autonomous Vehicle (CAV) Behavioral Adaptive Driving System,” which is assigned to the assignee hereof and incorporated by reference herein in its entirety for all purposes.

### BACKGROUND OF THE INVENTION

An increasing amount of modern day traffic comprises autonomous vehicles. Existing accident avoidance techniques implemented on autonomous vehicles have limited capabilities for dealing with suddenly occurring dangerous situations. This is partly because existing accident avoidance techniques are generally reactive in nature and lack the ability to predict and avoid potential risks. Although some existing models may provide a general estimation of what tends to happen for vehicle transport, such general estimations can be ineffective when dealing with ever-changing real-time traffic conditions.

### BRIEF SUMMARY OF THE INVENTION

Embodiments of the present technology may include a connected and autonomous vehicle (CAV). The CAV may include one or more sensors, a communications interface, a driving control configured to be activated to cause a change in the operation of the CAV, and a processing unit communicatively coupled with the one or more sensors, the communications interface, and the driving control. The processing unit may be configured to cause the CAV to obtain vehicle data regarding a vehicle using the one or more sensors, obtain, using the vehicle data, risk data via the communications interface, the risk data being indicative of a likelihood of an accident caused by the vehicle, and determine a risk value based on the risk data regarding the vehicle, the risk value being indicative of a likelihood that the CAV may be involved in an accident. The processing unit may be further configured to cause the CAV to, responsive to determining the risk value is above a threshold level, activate the driving control to modify the operation of the CAV.

In some embodiments, the one or more sensors may include a camera. The vehicle data may include one or more images of the vehicle. In some embodiments, the vehicle data may include vehicle identification information. The processing unit may be configured to cause the CAV to obtain the risk data by sending, via the communications interface, the vehicle identification information, and receiving, via the communications interface, the risk data. In some embodiments, the risk data may include at least one of insurance records, accident statistics, or directly observed driving behaviors. In some embodiments, the processing unit may be configured to cause the CAV to determine, based on the vehicle data, that the vehicle is driving erratically. In some embodiments, the processing unit may be configured to cause the CAV to, in response to determining the risk value is above the threshold level, send, via the communications interface, information indicative of: vehicle identification information of the vehicle, a location of the vehicle, the risk value, a time at which the vehicle data was obtained, or any combination thereof. In some embodiments, the one or more sensors may include a microphone. The vehicle data may include sounds in the environment of the CAV.

Embodiments of the present technology may also include a method of operating a connected and autonomous vehicle (CAV). The method may include obtaining vehicle data regarding a vehicle using one or more sensors of the CAV, obtaining, using the vehicle data, risk data indicative of a likelihood of an accident caused by the vehicle, and determining a risk value based on the risk data regarding the vehicle, the risk value being indicative of a likelihood that the CAV may be involved in an accident. In some embodiments, the method may further include, responsive to determining the risk value is above a threshold level, modifying the operation of the CAV.

In some embodiments, the one or more sensors may include a camera. The vehicle data may include one or more images of the vehicle. In some embodiments, the vehicle data may include vehicle identification information. Obtaining the risk data may include sending, via a communications interface of the CAV, the vehicle identification information, and receiving, via the communications interface of the CAV, the risk data. In some embodiments, the risk data may include at least one of insurance records, accident statistics, or directly observed driving behaviors. In some embodiments, the method may further include processing the vehicle data to determine that the vehicle is driving erratically. In some embodiments, the method may further include, responsive to determining the risk value is above the threshold level, determining an accident avoidance technique. Modifying the operation of the CAV may include modifying the operation of the CAV based at least in part on the determined accident avoidance technique. In some embodiments, the method may further include, responsive to determining the risk value is above the threshold level, sending, via a communications interface of the CAV, information indicative of: vehicle identification information of the vehicle, a location of the vehicle, the risk value, a time at which the vehicle data was obtained, or any combination thereof. In some embodiments, the one or more sensors may include a microphone. The vehicle data may include sounds in the environment of the CAV.

Embodiments of the present technology may further include a non-transitory machine readable medium having instructions stored thereon for operating a connected and autonomous vehicle (CAV). The instructions may be executable by one or more processors to cause the CAV to obtain vehicle data regarding a vehicle using one or more sensors of the CAV, obtain, using the vehicle data, risk data indicative of a likelihood of an accident caused by the vehicle, and determine a risk value based on the risk data regarding the vehicle, the risk value being indicative of a likelihood that the CAV may be involved in an accident. The instructions may be executable by one or more processors to further cause the CAV to, responsive to determining the risk value is above a threshold level, modify the operation of the CAV.

In some embodiments, the one or more sensors may include a camera. The vehicle data may include one or more images of the vehicle. In some embodiments, the vehicle data may include vehicle identification information. The instructions may be further executable by the one or more processors to cause the CAV to send, via a communications interface of the CAV, the vehicle identification information, and receive, via the communications interface of the CAV, the risk data. In some embodiments, the risk data may include at least one of insurance records, accident statistics, or directly observed driving behaviors. In some embodiments, the one or more sensors may include a microphone. The vehicle data may include sounds in the environment of the CAV. In some embodiments, the instructions may be further executable by the one or more processors to cause the CAV to determine, based on the vehicle data, that the vehicle is driving erratically. In some embodiments, the instructions may be further executable by the one or more processors to cause the CAV to, in response to determining the risk value is above the threshold level, send, via a communications interface of the CAV, information indicative of: vehicle identification information of the vehicle, a location of the vehicle, the risk value, a time at which the vehicle data was obtained, or any combination thereof.

### BRIEF DESCRIPTION OF THE DRAWINGS

For a more complete understanding of this invention, reference is now made to the following detailed description of the embodiments as illustrated in the accompanying drawings, in which like reference designations represent like features throughout the several views and wherein:

FIG. 1 is a simplified illustration of an environment in which a connected and autonomous vehicle (CAV) may operate, according to an embodiment;

FIG. 2 is a block diagram of components that may be included in a CAV for operating the CAV, according to an embodiment;

FIG. 3 is a flow chart illustrating the functionality of accident likelihood evaluation by a CAV, according to an embodiment;

FIG. 4 is a flow diagram illustrating a process of obtaining risk data about a vehicle, according to an embodiment; and

FIG. 5 is a flow diagram illustrating a method of operating a CAV, according to an embodiment.

In the appended figures, similar components and/or features may have the same reference label. Further, various components of the same type may be distinguished by following the reference label by a dash and a second label that distinguishes among the similar components. If only the first reference label is used in the specification, the description is applicable to any or all of the similar components having the same first reference label irrespective of the second reference label.

### DETAILED DESCRIPTION OF THE INVENTION

The ensuing description provides embodiments only, and is not intended to limit the scope, applicability or configuration of the disclosure. Rather, the ensuing description of the embodiments will provide those skilled in the art with an enabling description for implementing an embodiment. It is understood that various changes may be made in the function and arrangement of elements without departing from the scope.

Embodiments of the invention(s) described herein are generally related to autonomous road transport. That said, a person of ordinary skill in the art will understand that alternative embodiments may vary from the embodiments discussed herein, and alternative applications may exist.

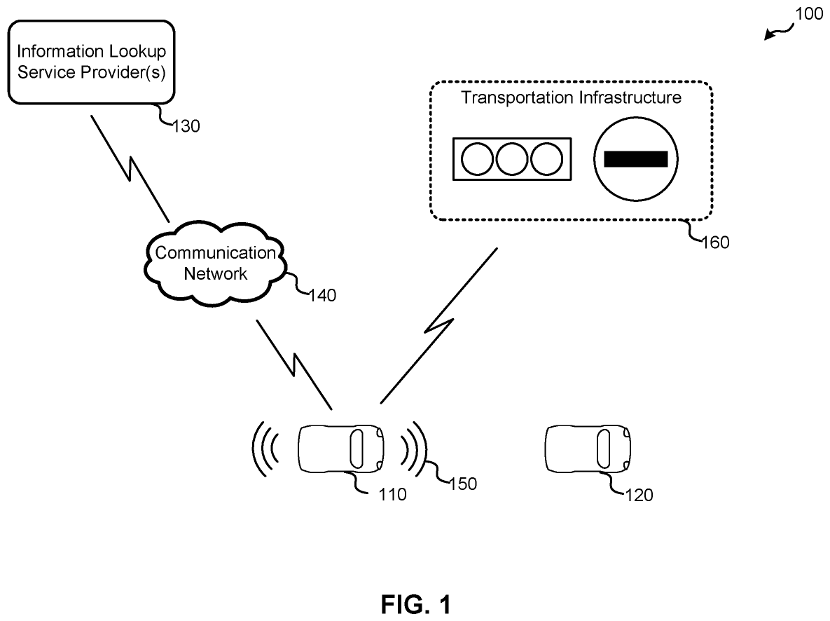

FIG. 1 is a simplified illustration of an environment 100 in which an autonomous vehicle 110 may operate, according to an embodiment. The autonomous vehicle 110 may be a connected vehicle configured to communicate with other devices, including other vehicles, as will be discussed in more detail below. The vehicle 110 may further include one or more sensors for assisting the operation of the vehicle 110, as will also be discussed in more detail below. The autonomous vehicle 110 thus may be referred to as a connected and autonomous vehicle (CAV) 110 or a sensor-assisted vehicle (SAV) 110. There may also be another vehicle 120 operating in the environment 100. The vehicle 120 may be another autonomous vehicle or may be operated by a human driver. Although only one CAV 110 and one other vehicle 120 are shown, there may be many more other vehicles also operating in the environment 100.

When it comes to avoiding collisions, both human-operated vehicles and autonomous vehicles have their limitations. Existing collision warning and automated braking systems will identify the vehicle in front braking hard and then warn the driver and/or automatically engage the vehicle's brakes. Thus, the existing collision avoidance techniques are generally reactive in nature in that operation of the vehicle is changed in response to the occurrence of a dangerous situation. These conventional collision avoidance techniques generally lack the ability to operate or maneuver the vehicle in a manner to avoid potential dangers that may occur.

Additionally, existing collision avoidance techniques treat other vehicles as general moving objects and react based on how far the moving object is and/or at what speed the moving object is traveling. The existing collision avoidance techniques do not take into account unique characteristics and/or history associated with individual vehicles. For example, existing collision avoidance techniques, including those implemented in autonomous vehicles, do not base their decisions on a specific vehicle's known driving habits or behavior. Instead, the existing decision making process may simply be based on a general estimation of what tends to happen for vehicle transport (see, e.g., https://www.annualreviews.org/doi/pdf/10.1146/annurev-control-060117-105157). Problematically, this fails to accommodate for the seemingly “unpredictable” real-time situations on the road.

Further, a human operator may, based on the years of experience the driver has, predict and thus avoid accidents that may be caused by another vehicle. Unlike a human, a machine does not have a “hunch,” and thus it can be very difficult for machines or autonomous vehicles to predict and avoid a dangerous situation that may be caused by, e.g., sudden movements of another vehicle.

To reduce the likelihood of being involved in an accident, embodiments of the CAV 110 described herein may implement defensive driving upon identifying high-risk drivers, vehicles, and/or areas, using details beyond the simple general estimation discussed above. A threat level posed by other vehicles may be calculated based on past information about the other vehicle operating in the environment 100, and/or based on the present driving behavior observed by the CAV 110. This can reduce the probability of the CAV 110 being involved in an accident as a risk level may be estimated before a dangerous situation occurs, and the CAV 110 may adjust its operation accordingly.

As mentioned above, the CAV 110 may include communication capabilities. In some embodiments, the CAV 110 may be configured to communicate with one or more information lookup service providers 130 over a communication network 140 in accordance with one or more wireless communication protocols. As will be discussed in more detail below, the information lookup service providers 130 may provide various information to the CAV 110 about the other vehicles also operating in the environment 100 for the CAV 110 to evaluate a risk or threat that may be posed to the CAV 110 by the other vehicles. For example, the CAV 110 may detect and consistently monitor other vehicles. Using its sensors and analytics capabilities, the CAV 110 may obtain identification information about the other vehicles. The CAV 110 may send the vehicle identification information to one or more of the information lookup service providers 130 and request in return additional vehicle information and/or risk data, such insurance records, accident statistics, associated with the vehicle. The CAV 110 may then perform an accident likelihood evaluation based on the additional vehicle information and/or risk data received to determine whether any of the other vehicles poses a high risk to the CAV 110.

The risk evaluation may be performed based on past or prior data about the other vehicles, and may be performed even when the other vehicles may be operating in the environment 100 in a safe manner. Based on the risk evaluation, the CAV 110 may determine whether and how to take action to avoid the risk. The CAV 110 may change its operation and drive more defensively so as to avoid being involved in a potential accident that may be caused by the other vehicles.

In some embodiments, the CAV 110 may further detect present dangers created by other vehicles, such as erratic driving of other vehicles. The CAV 110 may adjust its operation accordingly to avoid such present dangers. In some embodiments, the CAV 110 may further communicate such present dangers to other vehicles that may also be affected. In some embodiments, the CAV 110 may broadcast information about the present danger to other vehicles directly. For example, in some embodiments, the CAV 110 may broadcast short or medium range communication signals 150 for establishing communication directly with other vehicles using Wi-Fi, Bluetooth™, or the like. In some embodiments, the CAV 110 may communicate the information about the present danger to other vehicles via the communication network 140. In some embodiments, the CAV 110 may communicate information about the present danger to the transportation infrastructure 160. For example, the transportation infrastructure 160 may include traffic lights, traffic signs, and the like that may have communication capabilities. The transportation infrastructure 160 thus may be able to receive information from the CAV 110 and further relay the information received from the CAV 110 to other vehicles, or vice versa.

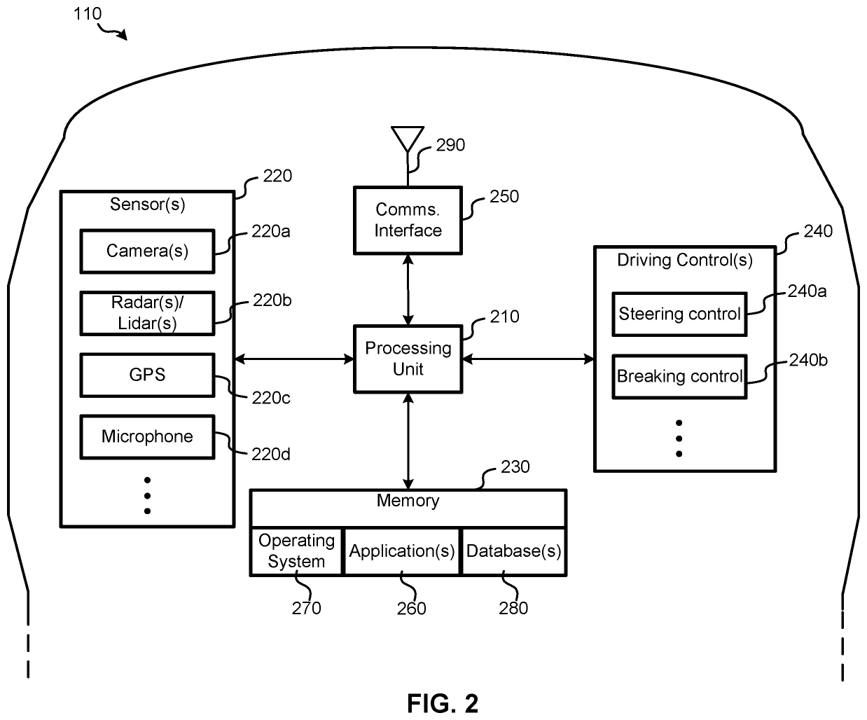

FIG. 2 is a block diagram of components that may be included in a CAV 110 for operating the CAV 110, according to an embodiment. The CAV 110 may include a processing unit 210, various sensors 220, memory 230, various driving controls 240, and communications interface 250. The components illustrated in FIG. 2 are provided as illustrative examples only. Embodiments may have additional or alternative components, may utilize any or all of the illustrated components or other types of components, and/or may utilize multiple components of the same type, depending on desired functionality. Arrows illustrated in FIG. 2 represent communication and/or physical links between the various components. Communication links may be direct (as shown) and/or implemented via a data bus. The communication links may be wired or wireless.

As discussed above, the CAV 110 may evaluate the risk or the likelihood of the CAV 110 being involved in an accident, and adjust the operation of the CAV 110 accordingly. To implement this functionality, the CAV 110 may detect and monitor other vehicles on the road using one or more of its sensors 220, such as camera(s) 220a, radar(s)/lidar(s) 220b, etc. The CAV 110 may further use its positioning sensor, such as a global positioning system (GPS) 220c, to determine the locations of the other vehicles detected. In some embodiments, a vehicle may be first generally detected as a moving object, and then determined to be a motor vehicle by analyzing the sensor inputs. For example, the size and/or speed of the moving object may be analyzed. If the size and/or speed may be determined to be greater than certain thresholds, then the moving object is more likely to be a motor vehicle instead of a human or bicycle. In some embodiments, the memory 230 may include applications 260 for implementing such analysis. In some embodiments, some of the sensors 220 may be equipped with its own processor, memory, and/or applications for carrying out such analysis.

The CAV 110 may further obtain vehicle data, such as identification information, of a vehicle detected. For example, using the camera(s) 220a, the CAV 110 may obtain one or more images and/or videos of the detected vehicle. Image analysis, specifically plate recognition, may be performed to convert the captured identification information in the image/video format to a string of character or numbers. The plate recognition may be performed by the processing unit 210 executing applications 260 installed in the memory 230 or by the processor, memory, and/or the applications of the camera(s) 220a capturing the image/video of the plate.

The CAV 110 may then send the vehicle identification information to one or more information lookup service providers, requesting further data or information about the vehicle for evaluating the likelihood of being involved in an accident that may be caused by the detected vehicle. The CAV 110 may be configured to communicate with the information lookup service providers via its communications interface 250. Various information may be returned by different information lookup service providers. For example, the information lookup service providers may include government bodies that collect vehicle registration information or other entities who may have access to such information and/or collect similar information. By sending the vehicle identification information to such entities, the CAV 110 may obtain in return additional vehicle information about the vehicle detected, such as registered driver, make, model, color, engine size, vehicle age, and weight, etc.

In some embodiments, the CAV 110 may send the additional vehicle information to other information lookup service providers, requesting information or data that may be useful for the CAV 110 to evaluate a risk that may be posed by the vehicle. In some embodiments, the information lookup service providers may further include insurance companies or similar entities that maintain insurance records, collect accident data, such as accident history of the particular vehicle and accident statistics of vehicles of the same or similar make, model, age, color, weight, engine size, etc., maintenance and/or repair data, and/or other information or statistics. In some embodiments, the CAV 110 may further send location information that may be collected by the position sensor, e.g., GPS 220c, of the CAV 110 to appropriate information lookup service providers to obtain statistics or data specific to the area the CAV 110 is travelling. The various statistics or information returned by the various information lookup service providers may be collectively referred to as risk data that may be utilized by the CAV 110 to evaluate the risk or likelihood of the CAV 110 being involved in an accident caused by the vehicle detected.

Although multiple information lookup service providers are described, in some embodiments, a single information lookup service provider may collect the various vehicle information and statistics discussed above and provide relevant risk data to the CAV 110 upon request. In some embodiments, the CAV 110 may include database(s) 280 in the memory 230 that also contain vehicle data and/or risk data. For example, the date store(s) 280 may include vehicle information and/or risk data the CAV 110 previously obtained from information lookup service providers, and/or vehicle data and/or risk data that the CAV 110 may collect on its own during operation. For example, the CAV 110 may observe unsafe driving behavior or dangerous maneuver performed by other vehicles. The CAV 110 may store the information based on such observation and associate the observed behavior with the vehicle observed and/or a more general group of vehicles, such as vehicles of the same make, model, color, engine size, age, etc. In some embodiments, the CAV 110 may also observe potential dangerous conditions associated with a particular location, such as road damage, on-going construction, etc., which may also be stored locally in the database(s) 280.

Based on the risk data gathered from remote information lookup service providers and/or locally, the CAV 110 may determine a risk value based on the risk data. An algorithm for determining the risk value may be stored as one of the application(s) 260 in the memory 230. The processing unit 210 may execute the algorithm or application to process the risk data and return a risk value indicative of the likelihood that the CAV 110 may be involved in an accident. The risk value may then be compared to a threshold value.

If the risk value is above the threshold value, indicating a high risk of the CAV 110 being involved in an accident that may be caused by the vehicle, the CAV 110 may then determine best action to take to avoid such risk. In some embodiments, the database(s) 280 may include accident avoidance techniques. An algorithm for determining which accident avoidance technique to be implemented may be stored as one of the application(s) 260 in the memory 230. Execution of the algorithms or applications by the processing unit 210 may determine which accident avoidance techniques to implement, and implement the accident avoidance techniques by causing one of the driving controls 240 to be activated to cause change in the operation of the CAV 110. For example, a steering control 240a may be activated if changing the travel path or direction of the CAV 110 is determined to be the accident avoidance technique to implement to avoid the risk. The activation of the steering control 240a may cause the wheels of the CAV 110 to be turned, which further resulting in the change in the travel path or direction of the CAV 110. As another example, if slowing down is determined to be the accident avoidance techniques to implement, then a breaking control 240b may be activated, which may cause the brake of the CAV 110 to be applied to slow down the CAV 110. Various other driving controls 240 may be activated to cause change in the operation of the CAV 110. Although multiple driving controls are illustrated as separate blocks, the various driving controls may be merged and combined.

In some embodiments, the CAV 110 may further detect present dangers using one of more of its sensors 220, in addition to evaluating potential threats or risks. For example, the CAV 110 may also use audio sensors, such as microphone 220d, to detect particular sounds in the environment that can indicate present danger, such as a heavily revved engine, emergency siren, etc. As another example, a vehicle driving differently from vehicles around it or erratically, such as swerving, driving too fast/slow, etc., may be detected by the camera 220a or other sensors of the CAV 110. Upon detection of the present dangers, the CAV 110 may disregard or give less weight to certain risk data, may increase the risk value previously determined, and/or even override the risk value. The algorithm may select the best accident avoidance techniques to implement based on the present danger alone, the increased risk value alone, or a combination of both.

In some embodiments, the CAV 110 may communicate information about the present danger, such as the vehicle posing the danger, the location of vehicle, the dangerous behavior observed, etc., to other vehicles that may also be affected via its communications interface 250. In some embodiments, the information of the present danger may be broadcasted to other nearby vehicles directly from the CAV 110. In some embodiments, the information of the present danger may be transmitted over a communication network or via the transportation infrastructure, such as connected traffic lights or signs capable of communicating with vehicles. In some embodiments, the risk value of the detected vehicle may also be passed onto other vehicles by the CAV 110.

As already mentioned above, the functionality of the CAV 110 described above may be caused by the processing unit 210 executing one or more applications 260, which may be stored in the memory 230. The processing unit 210 may additionally or alternatively execute an operating system 270 which also may be stored in the memory 230. The application(s) 260 may therefore be executable for the operating system 270. The processing unit 210 which may comprise without limitation one or more general-purpose processors, one or more special-purpose processors (e.g., application specific integrated circuits (ASICs), and/or the like), reprogrammable circuitry, and/or other processing structure or means, which can be configured to cause the CAV 110 to perform the functionality described herein.

It can be further noted that memory 230 may comprise non-transitory machine-readable media. The term “machine-readable medium” and “computer-readable medium” as used herein, refer to any storage medium that participates in providing data that causes a machine to operate in a specific fashion. In embodiments provided hereinabove, various machine-readable media might be involved in providing instructions/code to processing units and/or other device(s) for execution. Additionally or alternatively, the machine-readable media might be used to store and/or carry such instructions/code. In many implementations, a computer-readable medium is a physical and/or tangible storage medium. Such a medium may take many forms, including but not limited to, non-volatile media, volatile media, and transmission media. Common forms of computer-readable media include, for example, magnetic and/or optical media, any other physical medium with patterns of holes, a RAM, a PROM, EPROM, a FLASH-EPROM, any other memory chip or cartridge, a carrier wave as described hereinafter, or any other medium from which a computer can read instructions and/or code.

The communications interface 250 can enable communications between the CAV 110 and the other entities, such as information lookup service providers, other connected vehicles, the transportation infrastructure, etc., via an antenna 290. The communications interface 250 may communicate using any of a variety of close, medium, and/or long range wireless communication protocols, e.g., Bluetooth™, IEEE 802.11 (including Wi-Fi), IEEE 802.15.4 (including Zigbee™), WiMAX™, cellular communication, and/or the like. As such, the communications interface 250 may include any number of hardware and/or software components supporting such communications, such as a network card, an infrared communication device, a wireless communication device, a chipset, and/or the like. In some embodiments, the communications interface 250 may additionally or alternatively communicate using wired technologies.

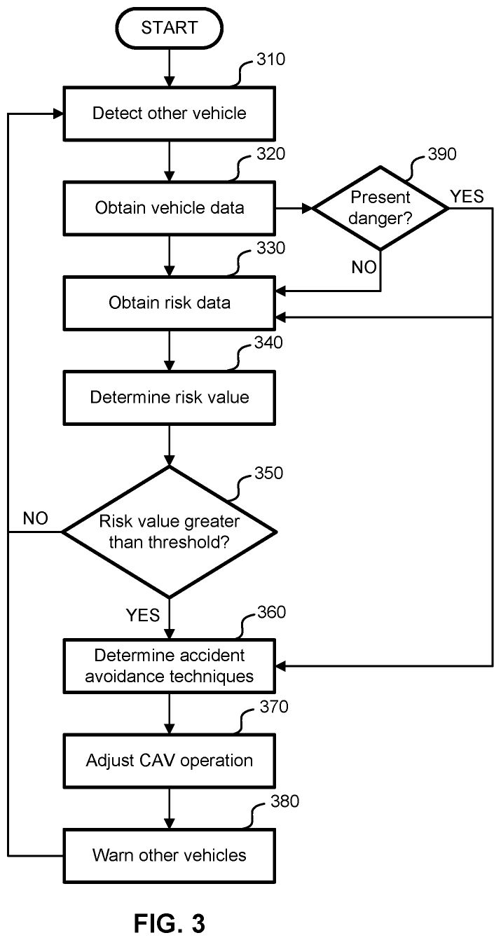

FIG. 3 is a flow chart illustrating the functionality of a CAV 110 for evaluating the likelihood of accidents, according to an embodiment. As such, the functionality of the various blocks within the flow chart may be executed by hardware and/or software components of the CAV 110 as described above. It is noted that alternative embodiments may alter the functionality illustrated to add, remove, combine, separate, and/or rearrange the various functions shown. A person of ordinary skill in the art will appreciate such variations.

Initially (e.g., when starting to operate on the road), at block 310, the CAV 110 may detect and/or become aware of other vehicles on the road by constantly monitoring other vehicles and/or object on the road based on input from various sensors of CAV 110, such as cameras, radars, lidars, positioning sensors (e.g., GPS), and the like. For example, uses its array of sensors, the CAV 110 may detect an object and then determine whether the detected object is a motor vehicle. In some embodiments, the CAV 110 may determine whether the detected object is a motor vehicle by determining whether the size of the object is bigger than a bicycle. In some embodiments, the CAV 110 may perform such determination using, e.g., images and/or videos captured by the cameras of the CAV 110. If so, the CAV 110 may determine that the detected object is likely to be a motor vehicle. Various other techniques for determining whether an object is likely to be a motor vehicle may be implemented. The CAV 110 may be configured to detect vehicles and/or objects at distances within, as well as greater than the maximum breaking distance for the speed the CAV 110 is travelling.

At block 320, once the CAV 110 detects another vehicle, the CAV 110 may obtain vehicle data of the vehicle. In some embodiments, obtaining vehicle data may include obtaining vehicle identification information, such as a registration plate, of the vehicle. For example, the CAV 110 may use its camera to capture one or more images and/or videos of the vehicle and/or the vehicle's registration plate. The CAV 110 may then use its image and/or video analysis capabilities, such as automatic plate-number/character recognition, to recognize the numbers and/or characters of the registration plate in the image and/or video and store the recognized string of numerical or character data. In some embodiments, the same images and/or videos used for detecting the vehicle at block 310 may also be used for obtaining the vehicle identification information. Thus, utilizing the captured images and/or videos, the CAV 110 may obtain vehicle identification information, e.g., the registration plate. In some embodiments, alternative or in additional to obtaining the vehicle identification information using its sensors and analytics capabilities, the CAV 110 may be configured to obtain the vehicle identification information by establishing communication with the vehicle when the other vehicle is also a connected vehicle. Although a registration plate is described herein as an example of the vehicle identification information, the CAV 110 may obtain other vehicle identification information, such as vehicle identification number (VIN) and the like, using its sensors, analytics capabilities, and/or communication with the detected vehicle, or any other methods.

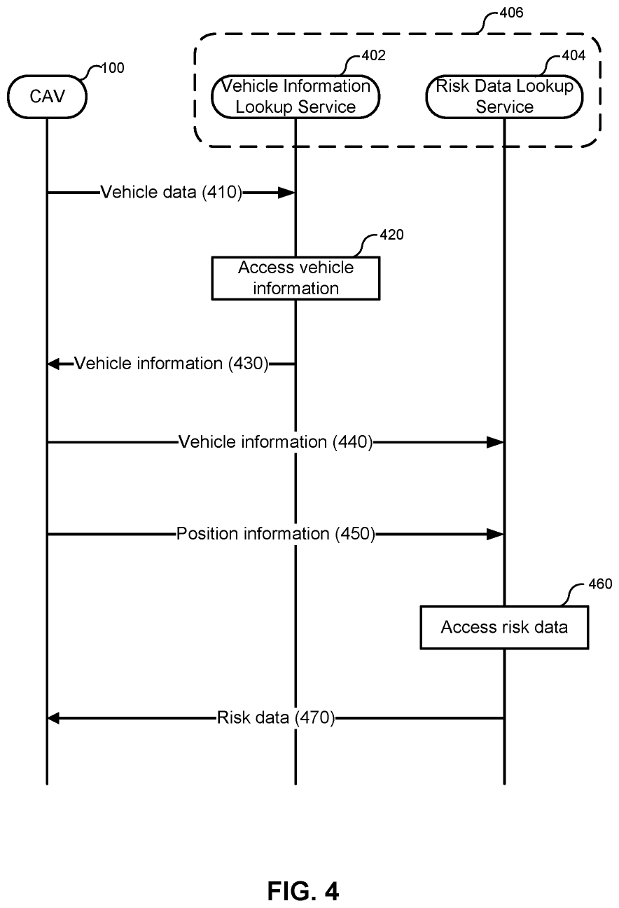

At block 330, the vehicle data, such as the vehicle identification information, may be used to obtain risk data about the vehicle. FIG. 4 is a flow diagram illustrating a process of obtaining risk data about a detected vehicle, according to an embodiment. In some embodiments, the CAV 110 may send information to one or more information lookup service providers, to obtain the risk data associated with the vehicle in real time. For example, the CAV 110 may communicate with the computer servers of the information lookup service providers via its communications interface through a communication network as discussed above.

In some embodiments, the CAV 110 may send the vehicle data to a vehicle information lookup service provider 402 (operation 410). In some embodiments, the vehicle information lookup service provider 402 may include government bodies that collect vehicle registration information and/or other entities who may have access to such vehicle registration information. Based on the vehicle data received, such as vehicle identification information (e.g., registration plate), the vehicle information lookup service provider 402 may look up and/or access vehicle information (operation 420) and send the vehicle information associated with the vehicle back to the CAV 110 (operation 430). For example, the vehicle information lookup service provider 402 may identify the driver, obtain the make, model, color, weight, age, engine size, etc., of the vehicle, and include the accessed information as part of the vehicle information to be provided to the CAV 110.

Thus, by providing appropriate vehicle data to the vehicle information lookup service provider 402, vehicle information may be obtained in real time. The term “real time” used herein is not intended to limit the time between the detection of another vehicle by the CAV 110 and the receipt of the vehicle information to be within a particular range. Rather, the term “real time” is used to indicate that the vehicle information or other information may be requested immediately upon or soon after detection of another vehicle, even though receipt of the requested information may be delayed to some extent due to various reasons.

Upon receipt of the vehicle information, in some embodiments, the CAV 110 may send the vehicle information to another information lookup service provider, such as an risk data lookup service provider 404 (operation 440), requesting risk data associated with the vehicle to be returned. The risk data lookup service provider 404 may include insurance companies that maintain and/or collect insurance records, accident statistics, repair statistics, or other similar statistics, and/or other entities who may have access to such records and/or statistics. The various risk data, such as the various records and statistics, may be indicative of a likelihood of an accident caused by the vehicle. In some embodiments, in addition to the vehicle information, the CAV 110 may send position information, such as the location where the CAV 110 is travelling or the other vehicle is detected, to the risk data lookup service provider 404 (operation 450). The location information may be obtained using the positioning sensor of the CAV 110. Although FIG. 4 illustrates two transmissions of the vehicle information and the position information, respectively, the vehicle information and the position information may be sent by the CAV 110 to the risk data lookup service provider 404 in one single transmission. The vehicle information and the position information are described as non-limiting examples of information the CAV 110 may send to the risk data lookup service provider 404 when requesting risk data. Other information that may be helpful for retrieving risk data, such as the time the other vehicle is detected, information about the CAV 110 itself, etc., may also be sent to the risk data lookup service provider 404 in the same transmission or via a separate transmission.

Based on the vehicle information and other information the risk data lookup service provider 404 may receive from the CAV 110, the risk data lookup service provider 404 may look up and/or access risk data (operation 460) and send the risk data back to the CAV 110 (operation 470). In some embodiments, the risk data may include specific records and/or statistics associated with the driver or the vehicle. In some embodiments, the risk data may include more general records and/or statistics associated the same or similar make, model, color, age, engine size, etc. Crime statistics, recent accident statistics, or other statistics that may be helpful in determining the risk of accidents in the area where the vehicle is detected or the CAV 110 is travelling may also be obtained as part of the risk data.

As mentioned earlier, conventional accident avoidance techniques are based on a “generic model” not specific to the vehicle that the CAV 110 detected. For example, in the “generic model” for assessing threats, the threat is assessed based on information such as 1 in 10,000 cars in general performing a dangerous maneuver causing an accident. In contrast, according to embodiments of accident likelihood evaluation by the CAV 110 as described herein, the CAV 110 may take into account additional factors that are specific to the vehicle the CAV 110 detects while operating on the road, leading to a more accurate threat assessment. As a non-limiting example, the CAV 110 may receive risk data such as 1 in 100 vehicles of a particular make and model that have performed a dangerous maneuver causing an accident, while 1 in 1000 vehicles of a different make and model that have performed a dangerous maneuver causing an accident.

Consequently, the CAV 110 may determine different treat or risk levels associated with different makes and models. A more accurate assessment of the risk level associated with the vehicle detected by the CAV 110 may be achieved by utilizing the risk data associated with the same make and model as the vehicle detected instead of risk data associated with all vehicles in general. Although make and model are described as examples, other information that is associated with and/or specific to the vehicle detected by the CAV 110 may be utilized when assessing the risk level, such as the driving history or record of the driver and/or the vehicle, and the like.

FIG. 4 illustrates two separate information lookup service providers, there may be more than two information lookup service providers to which the CAV 110 may send and request information for accident likelihood or risk evaluation. In some embodiments, the information provided by the two or more information lookup service providers may be consolidated and/or provided by one single information lookup service provider 406. The CAV 110 may only send the vehicle data obtained by the CAV 110 using its sensors, such as the vehicle identification information (e.g., registration plate), and obtain the risk data in return. In other words, the operations 430, 440, 450 illustrated in FIG. 4 may be omitted.

Further, although sending information to and requesting information from information lookup service providers are described as examples, the CAV 110 may store at least certain risk data locally. For example, the CAV 110 may store risk data previously obtained in its memory. The CAV 110 may also store risk data that the CAV 110 may collect on its own during operation. For example, the CAV 110 may observe unsafe driving behavior or dangerous maneuver performed by certain vehicles, although no risk data indicating such unsafe operation has been received. The CAV 110 may store information based on such observation and associate the observed behavior with the specific vehicle observed and/or a more general group of vehicles, such as vehicles of the same make, model, color, engine size, age, etc. Thus, when the CAV 110 observes the same vehicle or vehicles of the same or similar make, model, color, engine size, age, etc., next time, the CAV 110 may take into account the unsafe behavior previous observed in evaluating the risk level. In some embodiments, the CAV 110 may also observe dangerous conditions associated with a particular location, such as road damage, on-going construction, etc., which may also be stored locally. The information observed by the CAV 110 may be particularly relevant for assessing the risk level when similar behaviors or conditions have been observed multiple times, such as when the CAV 110 commutes along a route or travel around an area on a regular basis and/or encounters the same or similar vehicles frequently.

In some embodiments, depending on the information lookup service providers, the CAV 110 may send information the CAV 110 has collected to the information lookup service providers. For example, the information lookup service provider may be an operator of a fleet of or multiple connected vehicles or an entity that may be associated with or otherwise capable of communicating with the multiple connected vehicles directly and/or over a communication network. The information lookup service provider 406 may be one such entity in some embodiments. The entity may maintain one or more databases of various vehicle information and risk data. The databases may include information obtained from other information lookup service providers, such as the vehicle information lookup service provider 402 and the risk data lookup service provider 404. The databases may be augmented by the information received from the CAVs 110.

Referring back to FIG. 3, once the CAV 110 obtains the risk data locally and/or from one or more remote information lookup service providers, the CAV 110 may determine a risk value associated with the vehicle detected at block 340. The risk value may be indicative of the likelihood that the CAV may be involved in an accident, such as an accident that may be caused by the detected vehicle.

In some embodiments, the CAV 110 may calculate the risk value by assigning a score or value to each datum or each set of data included in the risk data. In some embodiments, the score or value may be assigned to each datum or set of data based on the relationship between the data and the vehicle detected. The more specific the data are to the vehicle detected, the higher the assigned score or value may be. For example, the data related to the accident history of the vehicle detected and/or the driver may be assigned a higher score or value than the data related to the accident statistics of the make and model in general. In other words, the CAV 110 may weigh the different data included in the risk data when determining the risk value. A higher weight may be given to data specific to the vehicle detected than to data that may be less specific to the vehicle detected. Then, the product and/or sum of the different scores or values associated with the data may be calculated as the risk value, in some embodiments.

In some embodiments, when determining the risk value, time or day the CAV 110 is traveling may also be considered, and the risk level may be adjusted accordingly. For example, the risk value may be increased at night, during rush hours, etc. Additionally, areas notorious for street racing may pose relatively low risk during the day but may pose much higher risk at other times, e.g., at midnight.

In some embodiments, the CAV 110 may also determine a geographic risk level based on the crime statistics, recent accident statistics, or other information related to the area in which the CAV 110 is traveling, such as weather condition or the like. The CAV 110 may assign scores or values to the various statistics and/or information, and, in some embodiments, the scores or values may be weighted. In some embodiments, the geographic risk level may be determined independent of the risk value. For example, the CAV 110 may not detect other vehicles at one moment when operating in certain area, but a geographic risk level may still be determined. In some embodiments, the geographic risk level may be determined as part of the determination of the overall risk value.

Once the risk value is determined, the CAV 110 may compare the determined risk value with a predetermined threshold level at block 350. If the risk value is determined to be no greater than the threshold level, then the CAV 110 may return to block 310 to continue monitoring other vehicles. If the risk value is determined to be greater than the threshold level, the CAV 110 may then determine how best to act at block 360. In some embodiments, the CAV 110 may look up in its own database, such as database 280 discussed above, how best to avoid the threat or risk. The database may include various accident avoidance techniques that the CAV 110 may implement to avoid different types of threats or risks.

In some embodiments, the database 280 may be preloaded with certain accident avoidance techniques, and the accident avoidance techniques may be continuously updated and/or modified as the CAV 110 operates on the road. For example, the CAV 110 may be equipped with machine learning capabilities. As the CAV 110 encounters various types of threats or risks during operation, the CAV 110 may take certain action, such as implementing one or more of the accident avoidance techniques in the database 280. The result of the action, e.g., whether the threat or risk is avoided, whether avoidance of the present threat put the CAV 110 in a subsequent dangerous situation, etc., may be measured. Over time, the CAV 110 may learn the best action to take when faced with certain types of threat or risks and update and/or optimize the accident avoidance techniques in the database accordingly. In some embodiments, learning may also be accomplished with human input or human intervention. For example, the CAV 110 may select from its database one or more accident avoidance techniques and suggest the same to the passenger in the CAV 110 by, e.g., presenting the suggested accident avoidance techniques on a display to the passenger. The passenger may decide whether to follow or override the suggested accident avoidance techniques. The suggested accident avoidance techniques, the human input, and the result thereof may be measured to determine the best course of action to take over time.

In some embodiments, the CAV 110 may also learn from other connected vehicles. The CAV 110 and other connected vehicles may share with each other via direct communication, via a communication network, or via the transportation infrastructure, the accident avoidance techniques implemented for different types of threats or risks and the results thereof. In some embodiments, the accident avoidance techniques, with or without human input, and/or the results may be uploaded to a remote database by many connected vehicles, and the remote database may be accessed by other connected vehicles. For example, the entity that collects risk data as discussed above may also collect the accident avoidance techniques and/or the results. Thus, accident avoidance techniques learned by other vehicles may be accessed by the CAV 110 to augment the accident avoidance techniques in its local database. When the accident avoidance techniques and the results may be pooled and/or shared, the learning and optimization of accident avoidance techniques for each connected vehicle, including the CAV 110, may be accomplished very quickly, especially compared to the years of time a human may take to gain all the knowledge and experience.

Once the CAV 110 determines the best action to take, the CAV 110 may adjust the operation of the CAV 110 based on the selected accident avoidance techniques accordingly at block 370. In some embodiments, the CAV 110 may operate more defensively by, e.g., increasing the breaking distance in view of the treat or risk that may be posed by the vehicle ahead. In some embodiments, the CAV 110 may avoid the threat or risk by changing lanes, yielding to a fast approaching vehicle, pulling over, choose a different travel route, etc.

In some embodiments, adjustment to the operation of the CAV 110 may also be based on the sensor input from the various sensors of the CAV 110, in addition to the determined accident avoidance technique. In other words, the adjustment may be based on a combination of the selected accident avoidance technique and the sensor input received. In some embodiments, the sensors of the CAV 110 may provide more updated or current information about the environment surrounding the CAV 110. For example, while the accident avoidance technique may suggest changing lanes to avoid the threat or risk of an unsafe vehicle ahead of the CAV 110, the sensor inputs may detect a vehicle in the blind spot rendering the lane changing at that moment unsafe. The accident avoidance technique may then be carried out at a later moment. Thus, in some embodiments, the CAV 110 may prioritize sensor inputs over the selected accident avoidance technique, and/or the accident avoidance technique may not override the sensor inputs.

In some embodiments, in addition to making adjustment to its own operation, the CAV 110 may also warn other vehicles of the risk at block 380. For example, the CAV 110 may pass information about the vehicle that poses a high risk onto other vehicles that may be further away (e.g., behind or ahead) but may also be affected. The information passed on may include information about the vehicle posing the risk, such as the vehicle identification information, time and/or location of the vehicle detected, and/or other information related to the vehicle and/or the risk posed by the vehicle. In some embodiments, the CAV 110 may also pass on information the CAV 110 obtained from the information lookup service providers, such as the vehicle information and/or the risk data obtained, and/or the risk value as determined by the CAV 110. In some embodiments, the other vehicles receiving such information may include connected vehicles. In some embodiments, the other vehicles receiving the information may not be a connected vehicle but may be otherwise capable of receiving the information, such as by receiving the information via an application installed on a communication device (e.g., cell phone) of the operator or a passenger. In some embodiments, the CAV 110 may further pass the information of a high-risk vehicle to the entity that collects risk data and/or accident avoidance techniques. In some embodiments, the CAV 110 may also pass on the information to law enforcement.

In some embodiments, the CAV 110 may pass on the information about the vehicle posing a high risk by broadcasting the information using medium or long range radio signals in accordance with one or more wireless communications protocols, such as Wi-Fi, Bluetooth™, WiMAX™, 3G, 4G, LTE, 5G, and/or other wireless communications protocols. In some embodiments, the CAV 110 may pass on the information to nearby vehicles via direct communication, over a communication network, or via the transportation infrastructure. In some embodiments, the CAV 110 may also receive information about a high-risk vehicle from other connected vehicles. The CAV 110 may then determine whether to act on such risk information. For example, in some embodiments, the CAV 110 may determine a risk value based on the information received, determine that its operation may be adjusted, determine one or more accident avoidance techniques to implement, and/or implement the accident avoidance techniques to modify its operation, as discussed above with reference to blocks 340-370.

In the embodiments described above, the risk value may be determined for any detected vehicle based on prior data associated with the vehicle, even though the detected vehicle may not be operating in a dangerous manner at the moment of detection. If the risk value indicates the detected vehicle poses a high risk or is likely to cause an accident, then the CAV 110 may implement appropriate accident avoidance techniques to avoid any potential accidents that may be caused by the vehicle, such as when the vehicle suddenly perform a dangerous maneuver. In other words, by consistently monitoring other vehicles, determining risk levels associated with the vehicles using prior data, the CAV 110 may “predict” potential dangers and drive more defensively to avoid being involved in such dangers. Because the risk evaluation or danger prediction is based on data or statistics, the evaluation or prediction as described herein may be more accurate as human opinions or biases may be reduced or eliminated when performing the risk evaluation. Further, because the risk evaluation or danger prediction is based on data or statistics more specific to the vehicle detected, the evaluation or prediction may be more accurate as compared to conventional models based on statistics generic to all road transport.

In some embodiments, in addition to evaluating or predicting potential accidents that may be caused other vehicles, the CAV 110 may further be configured to detect and/or react to present dangers. When present danger is detected, certain data, e.g., specific accident statistics, geographic risk level, etc., may be disregarded or given less weight upon detection of present dangers, and/or in some embodiments, the determined risk value may be overwritten by any present danger signs.

Specifically, in some embodiments, at block 320, obtaining vehicle data may further include obtain information indicative of present dangers. Some examples or signs of present dangers may include a vehicle driving differently from vehicles around it or erratically, such as swerving or weaving within lane and/or through lanes, driving too fast, too slow, accelerating, slowing down, etc. Such present danger signs may be detected or observed by the sensors of the CAV 110, such as cameras or other sensors of the CAV 110. The CAV 110 may also use audio sensors, such as microphones on the outside of the CAV 110, to detect particular sounds in the environment that can indicate present danger, such as a heavily revved engine of a vehicle standing in front of a traffic light, emergency siren, etc. Thus, obtaining the vehicle data at block 320 may further include receiving sensor inputs and/or analyzing sensor inputs indicative of the present driving behavior of other vehicles. For example, in some embodiments, using image and/or video analytics capabilities, the CAV 110 may process the image and/or video data of the cameras to determine the moving speed and/or direction of a vehicle for determining whether the vehicle is driving erratically. As another example, in some embodiments, using audio processing capabilities, which may be implemented as an application stored in the memory of the CAV 110 and/or an application stored in a memory of the audio sensor, the detected sound in the environment may be processed to detect a heavily revved engine, emergency siren, and the like, the location and/or direction thereof, etc. At block 390, the CAV 110 may determine the observed behavior pose a present danger to the CAV 110. In some embodiments, alternative to or in addition to obtaining information indicative of present dangers via its sensors, the CAV 110 may also receive information indicative of present dangers broadcasted or communicated by other connected vehicles directly, via a communications network, or via the transportation infrastructure.

If it is determined there is no present danger, then the CAV 110 may proceed to obtain the risk data at block 330. When a present danger is detected, in some embodiments, the CAV 110 may immediately proceed to block 360 to determine one or more accident avoidance techniques to implement to avoid the present danger, and adjust operation of the CAV 110 accordingly at block 370. In determining the accident avoidance techniques, the CAV 110 may disregard the risk value that may have been calculated for the vehicle posing the present danger. In some embodiments, when a present danger is detected, the CAV 110 may still proceed to obtain risk data at block 330 and/or determine a risk value for the vehicle observed at block 340, depending on the present danger detected. For example, when the CAV 110 detects a vehicle with heavily revved engine parked at the traffic light in front the CAV 110, the CAV 110 may still proceed to obtain risk data at block 330 and/or determine a risk value for the vehicle observed at block 340. Thus, the risk data for determining the risk value may also include observed driving behavior, such as the observed driving behavior of the vehicle creating the present danger. The CAV 110 may factor in the observed driving behavior creating the present danger and may disregard or give less weight to prior data, such as accident statistics, geographic risk level, etc., in determining the risk value. The CAV 110 may then proceed to block 360 to determine accident avoidance techniques to implement and adjust the operation of the CAV 110 accordingly at block 370. In some embodiments, the CAV 110 may further communicate information indicative of the present danger to other vehicles at block 380, passing on the details of vehicle and the observed behavior. The CAV 110 may further update the local and/or remote databases where risk data may be maintained to include information about the vehicle and the dangerous behavior observed.

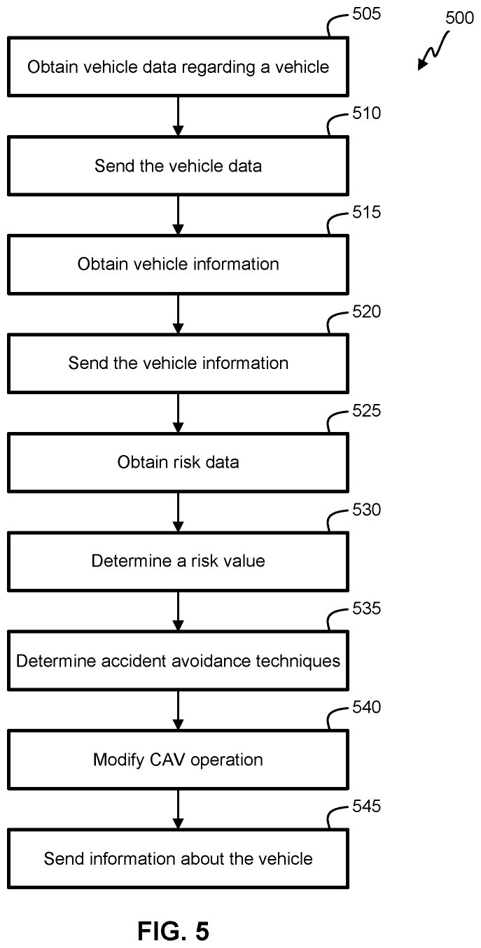

FIG. 5 is a flow diagram illustrating a method 500 of operating a CAV 110, according to an embodiment. The method 500 can be implemented by the CAV 110 as described herein, for example. As such, means for performing one or more of the functions illustrated in the various blocks of FIG. 5 may comprise hardware and/or software components of the CAV 110. As with other figures herein, FIG. 5 is provided as an example. Other embodiments may vary in functionality from the functionality shown. Variations may include performing additional functions, substituting and/or removing select functions, performing functions in a different order or simultaneously, and the like.

At block 505, the method 500 may include obtaining vehicle data regarding a vehicle. The vehicle data may be obtained by the CAV 110 using inputs from one or more sensors of the CAV 110, such as camera(s), radar(s), lidar(s), positioning sensors (e.g., GPS), audio sensors (e.g., microphone), etc. The sensors may be utilized to detect the vehicle and obtain the vehicle data of the vehicle. In some embodiments, images and/or videos of the vehicle may be captured by the camera(s) of the CAV 110. The images and/or videos of the vehicle may be processed to detect the vehicle and/or to obtain vehicle data of the vehicle as discussed above. For example, the images and/or videos of the vehicle may be processed to obtain vehicle identification information, such as a registration plate, of the vehicle. In some embodiments, vehicle data of the detected vehicle may be obtained via wireless communication that may be established with the detected vehicle using a communications interface of the CAV 110. The vehicle data obtained via such communication may include a vehicle identification number and/or other vehicle identification information, in addition to the registration plate.

At block 510, the method 500 may include sending the vehicle data, such as the vehicle identification information. In some embodiments, the vehicle data may be sent by the CAV 110 to a computer server of a first information lookup service provider. The CAV 110 may send the vehicle identification information using its communications interface over a network in accordance with one or more wireless communication protocols. The first information lookup service provider may have access to vehicle registration databases, which may include vehicle information, such as the registered driver, make, model, color, weight, age, engine size, etc., of the vehicle. Based on the vehicle data received, e.g., vehicle identification information, the first information lookup service provider may identify the relevant vehicle information and send the identified vehicle information over the network back to the CAV 110. The CAV 110 may then obtain the vehicle information at block 515 via its communications interface.

At block 520, the method 500 may also include sending the obtained vehicle information. The CAV 110 may send the vehicle information using its communications interface to a computer server of a second information lookup service provider. The second information lookup service provider may have access to risk data that may be indicative of a likelihood of an accident that may be caused by the vehicle. The risk data may include records and/or statistics, such as insurance records, accident data, e.g., accident history of the detected vehicle and accident statistics of vehicles of the same or similar make, model, age, color, weight, engine size, etc., maintenance and/or repair data, and/or other information or statistics. Based on the vehicle information received, the second information lookup service provider may identify the relevant risk data and send the identified risk data back to the CAV 110. The CAV 110 may then obtain the risk data at block 525 via its communications interface.

In some embodiments, the first and second information lookup service providers may be a common information lookup service provider. Thus, the functionality of blocks 515 and 520 may be omitted. The CAV 110 may send the vehicle data at block 510 and obtain in return the risk data at block 525, without obtaining the vehicle information at block 515 and/or sending the vehicle information at block 520.

In some embodiments, the risk data may further include driving behavior of the vehicle. As discussed above, the driving behavior of the vehicle may be detected or observed by the various sensors of the CAV 110. The observed driving behavior may be processed to determine whether the vehicle may pose a present danger to the CAV 110. For example, the cameras of the CAV 110 may observe that the vehicle is driving erratically, swerving, driving too fast/slow, etc. As another example, the microphone of the CAV 110 may detect the sound in the environment, such as the sound of a heavily revved engine, emergency siren, etc. The CAV 110 may determine that these and/or other driving behavior may pose a present danger to the CAV 110, then include the observed driving behavior as part of the risk data obtained by CAV 110.

At block 530, the method 500 may include, based on the obtained risk data, determining a risk value. The risk value may be indicative of a likelihood that the CAV 110 may be involved in an accident. Various techniques for determining the risk value as discussed above may be implemented. In some embodiments, if a driving behavior of the vehicle may indicate that the vehicle may pose a present danger to the CAV 110, the CAV 110 may give less weight or disregard other risk data received, such as the risk data received from the information lookup service providers, when determining the risk value. The determined risk value may be compared to a threshold level. If the risk value is determined to be above the threshold level, the method may proceed to block 535 to determine one or more accident avoidance techniques to implement so as to avoid the risk of being involved in an accident. In some embodiments, if a driving behavior posing a present danger is detected, functionality of blocks 510-530 may all be skipped, and the method may proceed to block 535 directly.

At block 535, the method 500 may include determining the one or more accident avoidance techniques to implement so as to avoid the risk of the CAV 110 being involved in an accident. In some embodiments, the accident avoidance techniques for avoiding each type of risks and/or threats posed by the other vehicles may be included in a database stored on the memory of the CAV 110. The database of the accident avoidance techniques may be continuously updated and/or modified. In some embodiments, the database of the accident avoidance techniques may be continuously updated and/or modified via, e.g., machine learning, without or without human input, as discussed above. The accident avoidance techniques may also be pooled and shared among multiple connected vehicles.

At block 540, the method 500 may further include modifying the operation of the CAV 110. The operation of the CAV 110 may be modified based on the determined accident avoidance techniques, as well as inputs from the various sensors of the CAV 110. In some embodiments, based on the accident avoidance techniques, one or more driving controls of the CAV 110 may be activated, and activation of the driving controls may cause the operation of the CAV 110 to change as discussed above. For example, when changing the travel path or direction of the CAV 110 is determined to be the accident avoidance technique to implement to avoid the risk, a steering control may be active to cause the wheels of the CAV 110 to be turned. As another example, when slowing down is determined to be the accident avoidance technique to implement, a breaking control may be activated to cause the brake of the CAV 110 to be applied. Multiple operational controls may be activated, depending on the accident avoidance technique(s) determined to be implemented. When implementing the accident avoidance techniques to modify the operation of the CAV 110, the CAV 110 may also take into account the sensor inputs of the CAV 110 about the current surroundings of the CAV 110. In some embodiments, the CAV 110 may prioritize sensor inputs over the selected accident avoidance techniques.

At block 545, in some embodiments, the method 500 may further include sending, via the communications interface of the CAV 110, information indicative of the risk and/or threat posed by the detected vehicle to other vehicles that may also be affected. In some embodiments, the information indicative of the risk and/or threat posed by the detected vehicle may be sent when a present danger is detected, such as when the CAV 110 determines that the detected vehicle is driving erratically, and/or when the CAV 110 detects the sound of a heavily revved engine and/or other driving behavior indicating a present danger. In some embodiments, the information indicative of the risk and/or threat posed by the detected vehicle may be sent when the risk value is determined to be greater than the threshold value, even when a present danger may not be detected. The information sent to other vehicles may include the vehicle identification information of the vehicle, the location of the vehicle, which may be determined using the GPS of the CAV 110, the risk value determined by the CAV 110, the time at which the vehicle data was obtained, and/or other information related to the risk and/or threat posed by the detected vehicle.

Various components may be described herein as being “configured” to perform various operations. Those skilled in the art will recognize that, depending on implementation, such configuration can be accomplished through design, setup, placement, interconnection, and/or programming of the particular components and that, again depending on implementation, a configured component might or might not be reconfigurable for a different operation. Moreover, for many functions described herein, specific means have also been described as being capable of performing such functions. It can be understood, however, that functionality is not limited to the means disclosed. A person of ordinary skill in the art will appreciate that alternative means for performing similar functions may additionally or alternatively be used to those means described herein.

It will be apparent to those skilled in the art that substantial variations may be made in accordance with specific requirements. For example, customized hardware might also be used, and/or particular elements might be implemented in hardware, software (including portable software, such as applets, etc.), or both. Further, connection to other computing devices such as network input/output devices may be employed.

The methods, systems, and devices discussed herein are examples. Various embodiments may omit, substitute, or add various procedures or components as appropriate. For instance, features described with respect to certain embodiments may be combined in various other embodiments. Different aspects and elements of the embodiments may be combined in a similar manner. The various components of the figures provided herein can be embodied in hardware and/or software. Also, technology evolves and, thus, many of the elements are examples that do not limit the scope of the disclosure to those specific examples.

While illustrative and presently preferred embodiments of the disclosed systems, methods, and machine-readable media have been described in detail herein, it is to be understood that the inventive concepts may be otherwise variously embodied and employed, and that the appended claims are intended to be construed to include such variations, except as limited by the prior art.

Unless defined otherwise, all technical and scientific terms used herein have the same meaning as commonly or conventionally understood. As used herein, the articles “a” and “an” refer to one or to more than one (i.e., to at least one) of the grammatical object of the article. By way of example, “an element” means one element or more than one element. “About” and/or “approximately” as used herein when referring to a measurable value such as an amount, a temporal duration, and the like, encompasses variations of ±20% or ±10%, ±5%, or +0.1% from the specified value, as such variations are appropriate to in the context of the systems, devices, circuits, methods, and other implementations described herein. “Substantially” as used herein when referring to a measurable value such as an amount, a temporal duration, a physical attribute (such as frequency), and the like, also encompasses variations of ±20% or ±10%, ±5%, or +0.1% from the specified value, as such variations are appropriate to in the context of the systems, devices, circuits, methods, and other implementations described herein.

The terms “and,” “or,” and “and/or” as used herein may include a variety of meanings that also are expected to depend at least in part upon the context in which such terms are used. Typically, “or” if used to associate a list, such as A, B or C, is intended to mean A, B, and C, here used in the inclusive sense, as well as A, B or C, here used in the exclusive sense. In addition, the term “one or more” as used herein may be used to describe any feature, structure, or characteristic in the singular or may be used to describe a plurality or some other combination of features, structures or characteristics. Though, it should be noted that this is merely an illustrative example and claimed subject matter is not limited to this example.

Reference throughout this specification to “one example,” “an example,” “certain examples,” or “exemplary implementation” means that a particular feature, structure, or characteristic described in connection with the feature and/or example may be included in at least one feature and/or example of claimed subject matter. Thus, the appearances of the phrase “in one example,” “an example,” “in certain examples,” “in certain implementations,” or other like phrases in various places throughout this specification are not necessarily all referring to the same feature, example, and/or limitation. Furthermore, the particular features, structures, or characteristics may be combined in one or more examples and/or features.

Unless specifically stated otherwise, as apparent from the discussion herein, it is appreciated that throughout this specification discussions utilizing terms such as “processing,” “computing,” “calculating,” “determining” or the like refer to actions or processes of a specific apparatus, such as a special purpose computer, special purpose computing apparatus or a similar special purpose electronic computing device. In the context of this specification, therefore, a special purpose computer or a similar special purpose electronic computing device is capable of manipulating or transforming signals, typically represented as physical electronic or magnetic quantities within memories, registers, or other information storage devices, transmission devices, or display devices of the special purpose computer or similar special purpose electronic computing device.

In the preceding detailed description, numerous specific details have been set forth to provide a thorough understanding of claimed subject matter. However, it will be understood by those skilled in the art that claimed subject matter may be practiced without these specific details. In other instances, methods and apparatuses that would be known by one of ordinary skill have not been described in detail so as not to obscure claimed subject matter.

While there has been illustrated and described what are presently considered to be example features, it will be understood by those skilled in the art that various other modifications may be made, and equivalents may be substituted, without departing from claimed subject matter. Additionally, many modifications may be made to adapt a particular situation to the teachings of claimed subject matter without departing from the central concept described herein.

Therefore, it is intended that claimed subject matter not be limited to the particular examples disclosed, but that such claimed subject matter may also include all aspects falling within the scope of appended claims, and equivalents thereof

What is claimed is:

1. A connected and autonomous vehicle (CAV), comprising:
one or more sensors;
a communications interface;
a driving control configured to be activated to cause a change in the operation of the CAV; and
a processing unit communicatively coupled with the one or more sensors, the communications interface, and the driving control, the processing unit being configured to cause the CAV to:
obtain vehicle data regarding a vehicle using the one or more sensors;
obtain, using the vehicle data, risk data via the communications interface, the risk data being indicative of a likelihood of an accident caused by the vehicle;
determine a risk value based on the risk data regarding the vehicle, the risk value being indicative of a likelihood that the CAV may be involved in an accident; and
responsive to determining the risk value is above a threshold level, activate the driving control to modify the operation of the CAV.

2. The CAV of claim 1, wherein the one or more sensors comprise a camera, and wherein the vehicle data comprises one or more images of the vehicle.

3. The CAV of claim 1, wherein the vehicle data comprises vehicle identification information, and wherein the processing unit is configured to cause the CAV to obtain the risk data by:
sending, via the communications interface, the vehicle identification information; and
receiving, via the communications interface, the risk data.

4. The CAV of claim 1, wherein the risk data comprises at least one of insurance records, accident statistics, or directly observed driving behaviors.

5. The CAV of claim 1, wherein the processing unit is configured to cause the CAV to determine, based on the vehicle data, that the vehicle is driving erratically.

6. The CAV of claim 1, wherein the processing unit is configured to cause the CAV to, in response to determining the risk value is above the threshold level, send, via the communications interface, information indicative of:
vehicle identification information of the vehicle;
a location of the vehicle;
the risk value;
a time at which the vehicle data was obtained; or
any combination thereof.

7. The CAV of claim 1, wherein:
the one or more sensors comprise a microphone; and
the vehicle data comprises sounds in the environment of the CAV.

8. A method of operating a connected and autonomous vehicle (CAV), the method comprising:
obtaining vehicle data regarding a vehicle using one or more sensors of the CAV;
obtaining, using the vehicle data, risk data indicative of a likelihood of an accident caused by the vehicle;
determining a risk value based on the risk data regarding the vehicle, the risk value being indicative of a likelihood that the CAV may be involved in an accident; and
responsive to determining the risk value is above a threshold level, modifying the operation of the CAV.

9. The method of operating the CAV of claim 8, wherein:
the one or more sensors comprise a camera; and
the vehicle data comprises one or more images of the vehicle.

10. The method of operating the CAV of claim 8, wherein:
the vehicle data comprises vehicle identification information; and
obtaining the risk data comprises:
sending, via a communications interface of the CAV, the vehicle identification information; and
receiving, via the communications interface of the CAV, the risk data.

11. The method of operating the CAV of claim 8, wherein the risk data comprises at least one of insurance records, accident statistics, or directly observed driving behaviors.

12. The method of operating the CAV of claim 8, further comprising:
responsive to determining the risk value is above the threshold level, determining an accident avoidance technique, wherein modifying the operation of the CAV comprising modifying the operation of the CAV based at least in part on the determined accident avoidance technique.

13. The method of operating the CAV of claim 8, further comprising, responsive to determining the risk value is above the threshold level, sending, via a communications interface of the CAV, information indicative of:
vehicle identification information of the vehicle;
a location of the vehicle;
the risk value;
a time at which the vehicle data was obtained; or
any combination thereof.

14. The method of operating the CAV of claim 8, wherein:
the one or more sensors comprise a microphone; and
the vehicle data comprises sounds in the environment of the CAV.

15. A non-transitory machine readable medium having instructions stored thereon for operating a connected and autonomous vehicle (CAV), wherein the instructions are executable by one or more processors to cause the CAV to:
obtain vehicle data regarding a vehicle using one or more sensors of the CAV;
obtain, using the vehicle data, risk data indicative of a likelihood of an accident caused by the vehicle;
determine a risk value based on the risk data regarding the vehicle, the risk value being indicative of a likelihood that the CAV may be involved in an accident; and
responsive to determining the risk value is above a threshold level, modify the operation of the CAV.

16. The non-transitory machine readable medium of claim 15, wherein the one or more sensors comprise a camera, and wherein the vehicle data comprises one or more images of the vehicle.

17. The non-transitory machine readable medium of claim 15, wherein the vehicle data comprises vehicle identification information, and wherein the instructions are further executable by the one or more processors to cause the CAV to:
send, via a communications interface of the CAV, the vehicle identification information; and
receive, via the communications interface of the CAV, the risk data.

18. The non-transitory machine readable medium of claim 15, wherein the risk data comprises at least one of insurance records, accident statistics, or directly observed driving behaviors.

19. The non-transitory machine readable medium of claim 15, wherein:
the one or more sensors comprise a microphone; and
the vehicle data comprises sounds in the environment of the CAV.

20. The non-transitory machine readable medium of claim 15, wherein the instructions are further executable by the one or more processors to cause the CAV to, in response to determining the risk value is above the threshold level, send, via a communications interface of the CAV, information indicative of:
vehicle identification information of the vehicle;
a location of the vehicle;
the risk value;
a time at which the vehicle data was obtained; or
any combination thereof.
